(19) United States
(12) Patent Application Publication
(10) Pub. No.: US 2004/0007190 A1
(43) Pub. Date: Jan. 15, 2004

(54) Hollow container molded from glass or other transparent material in various shapes and sizes to be used as a fishbowl, designed with indented hollow cavity hangers shaped in its back which will allow the fishbowl to be slipped on and removed from fasteners attached in a vertical wall, without removing the fasteners

(76) Inventors: Rebecca Lynn Covell, Phoenix, AZ (US); Joel Tracy Ireland, Tucson, AZ (US)

Correspondence Address: Joel T. Ireland, 532 E. 1st Street, Tucson, AZ, 85705, US

(21) Appl. No.: 10/218,786

(22) Filed: Aug. 14, 2002

Related U.S. Application Data
(60) Provisional application No. 60/395,919, filed on Jul. 15, 2002.

(51) Int. Cl. A01K 63/00

(52) U.S. Cl. 119/257

(57) ABSTRACT

A hollow container molded from glass or other transparent material in various shapes and sizes to be used as a fishbowl that will hang on a wall. The fishbowl is designed with two indented hollow cavity slots imbedded at the top of its back, which will allow the fishbowl to be placed on and removed from fasteners fixed in a wall, without removing the fasteners, for easy cleaning and maintenance. The benefit of this invention is that it is smaller than an aquarium, and is more properly categorized as a fishbowl. It is distinct from an aquarium in that it is one molded piece of glass with its hanging device formed in the back of the bowl itself. Installation is achieved by installing two simple screws in a vertical wall, which are hidden once the fishbowl is in place, leaving no awkward, unsightly exterior hanging device.

### CROSS-REFERENCE TO RELATED APPLICATIONS

Provisional Application No. 60/395,919, filed Jul. 15, 2002.

A hollow container molded from glass or other transparent material in various shapes and sizes to be used as a fishbowl, designed with indented hollow cavity hangers shaped in its back which will allow the fishbowl to be slipped on and removed from fasteners attached in a vertical wall, without removing the fasteners.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

1. Field of the Invention

This invention relates to a molded glass (or other transparent material) fishbowl designed to mount on a wall to display live fish and other water creatures as if it were a picture on a wall. The advantages of this invention are: (a) that the mounting devices are molded into the fishbowl itself and are designed to fit over two screws in a vertical wall to allow for easy placement and removal of the fish bowl for regular cleaning and changing water; (b) the mounting devices are simple, clean and hidden once the fishbowl is mounted, providing a clean installation; (c) the fishbowl is small and lightweight to aid in regular maintenance; and (d) the fishbowl is rimmed in its opening to prevent splashing of water during placement and removal.

2. Description of Related Art

There are many different types of aquariums in the prior art. Aquariums are manufactured by gluing flat pieces of glass to form the container. Of these aquariums, several are designed to be mounted on a wall. These fall into two distinct categories: (1) semi-permanent wall installations, which involve mounting the aquarium by driving screws through holes molded in the back or side planar surfaces of the aquarium, the screws of which must be removed in order to remove the aquarium; and (2) motile applications designed to make placement and removal of the aquarium possible without removing the hanging device. [0008] The semi-permanent installations do not allow for easy removal of an aquarium for regular maintenance. The motile applications designed to make removal easy are all designed with hanging devices separate from the aquarium that are awkward, unsightly, and difficult to use.

The benefit of this invention is that it is smaller than an aquarium, and is more properly categorized as a fishbowl. It is distinct from an aquarium in that it is one molded piece of glass with its hanging device formed in the back of the bowl itself. The screws on which it hangs do not have to be removed to remove the bowl. No exterior hanging device is required and installation is achieved by installing two simple screws in a vertical wall, which are hidden once the fishbowl is in place, leaving no awkward, unsightly exterior hanging device.

### BRIEF SUMMARY OF THE INVENTION

Our invention is a hollow container molded from glass or other transparent material in various shapes and sizes to be used as a fishbowl that will hang on a wall. The fishbowl of whatever shape or size is designed with two indented hollow cavity slots imbedded at the top of its back, near each back edge, which will allow the fishbowl to be placed on and removed from fasteners fixed in a wall, without removing the fasteners. The opening at the top of the fishbowl has a rim, which prevents splashing of water during the placement or removal of the fishbowl.

### BRIEF DESCRIPTION OF THE SEVERAL VIEWS OF THE DRAWINGS

FIG. 1. An oblique front view of the rectangular box fishbowl showing the shape and the opening at the top with a ¼″ rim around the entire top opening.

FIG. 2. A top view of the rectangular box fishbowl showing the top opening with a ¼″ rim around the entire top opening.

FIG. 3. An oblique rear view of the rectangular box fishbowl showing the placement of the indented hollow cavity slot hangers. The detail view indicated is more fully described in FIG. 13 and FIG. 14, which illustrate the indented hollow cavity slot hanger, which is the hanging feature that appears on every fishbowl in FIGS. 1 through 12 and 15.

FIG. 4. An oblique front view of the square box with barrel-shaped front (or square front) fishbowl showing the shape and the opening at the top with a ¼″ rim around the entire top opening.

FIG. 5. A top view of the square box with barrel-shaped front (or square front) fishbowl showing the shape and the opening at the top with a ¼″ rim around the entire top opening.

FIG. 6. A back view of the square box with barrel-shaped front (or square front) fishbowl showing the placement of the indented hollow cavity slot hangers.

FIG. 7. An oblique front view of the rectangular oval fishbowl showing the shape and the opening at the top with a ¼″ rim around the entire top opening.

FIG. 8. A top view of the rectangular oval fishbowl showing the top opening with a ¼″ rim around the entire top opening.

FIG. 9. An oblique back view of the rectangular oval fishbowl showing the placement of the indented hollow cavity slot hangers and the shape of the bottom. The space between the dotted lines is the portion of the back of the rectangular oval fishbowl which is flattened to accept the hollow cavity slot hangers and to lie flat against the wall.

FIG. 10. A view of the round fishbowl container showing the shape from the front.

FIG. 11. Top view of the round fishbowl container showing the half sphere shape of the bowl with a flat back and the top opening with a ¼″ rim around the entire top opening.

FIG. 12. Back view of the round fishbowl container showing the placement of the indented hollow cavity slot hangers in the flattened back.

FIG. 13. An oblique detailed view of the indented hollow cavity slot hanger. The view is of the back right corner placement, looking into the cavity toward the water side of the container from the back.

FIG. 14. A sectional view of the indented hollow cavity slot hanger, showing the shape of the hanger from the side and illustrating that the cavity is indented ¼″ into the ⅜″ thickness of the glass back of the container. ⅛″ of glass separates the interior surface of the cavity from the water in the fish bowl. The top edge of the cavity slants upward from the face of the back to the interior surface of the cavity to provide space into which the head of fasteners may slide. The cavity is open in the front to allow the cavity to be placed over the head of a fastener.

FIG. 15. An oblique view of the triangular fishbowl showing the top opening with a ¼″ rim around the entire top opening and the placement of the indented hollow cavity slot hangers.

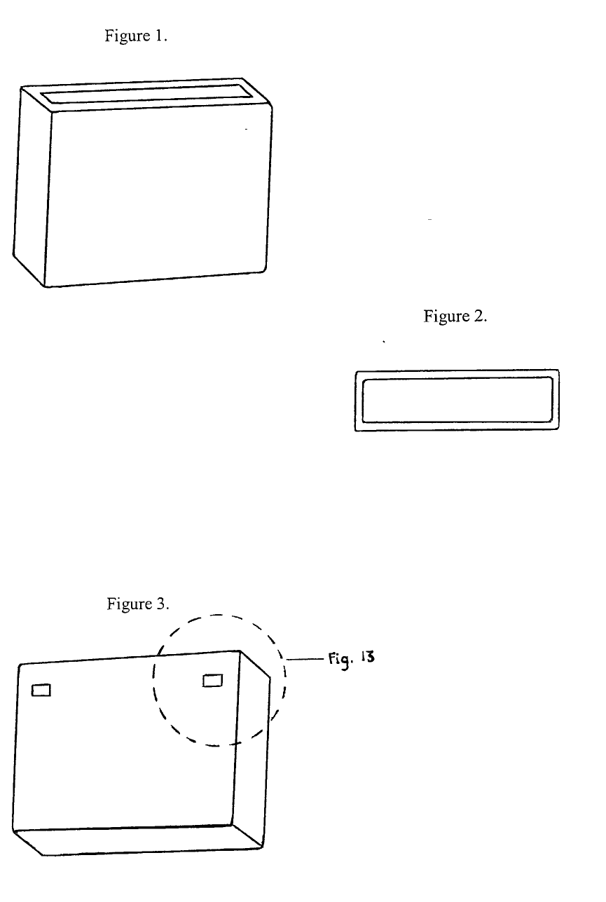

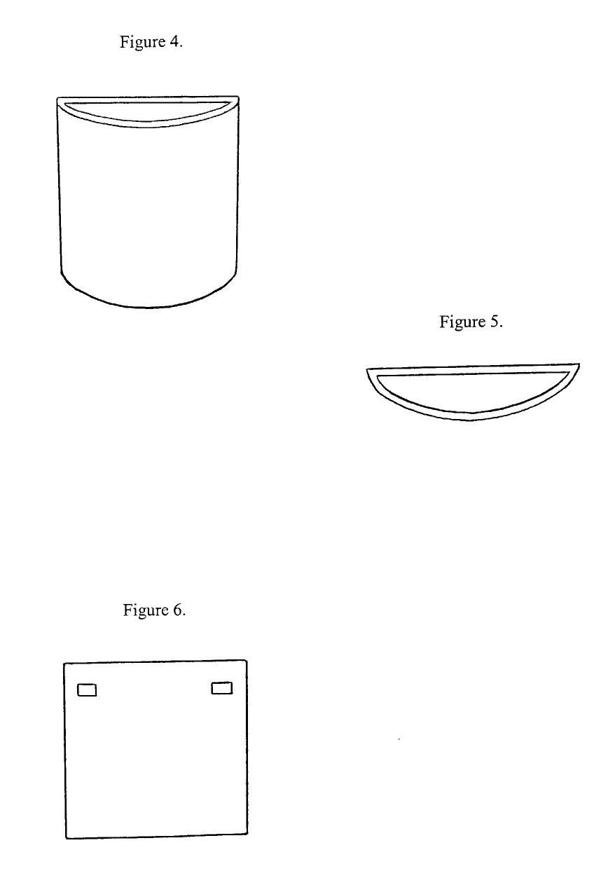

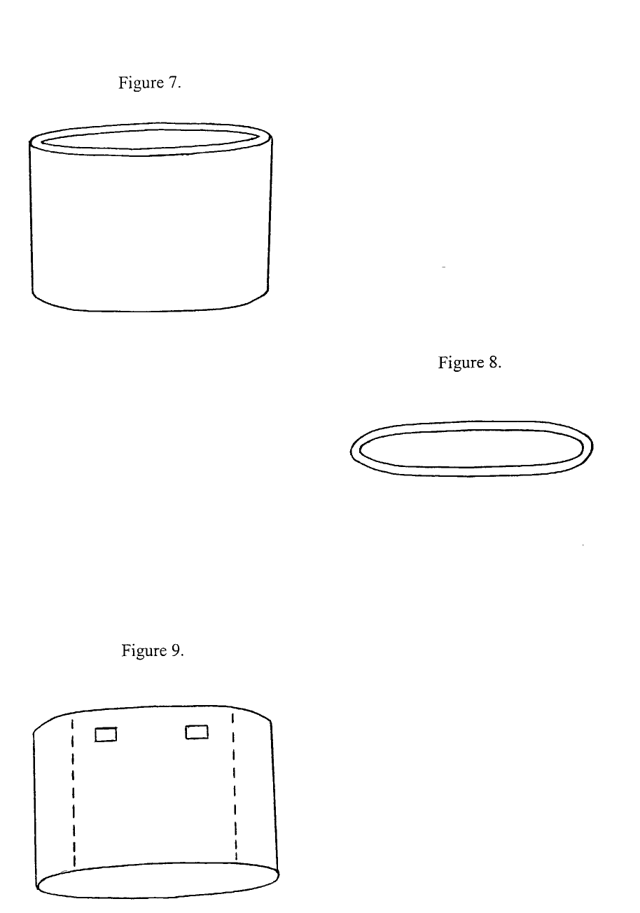

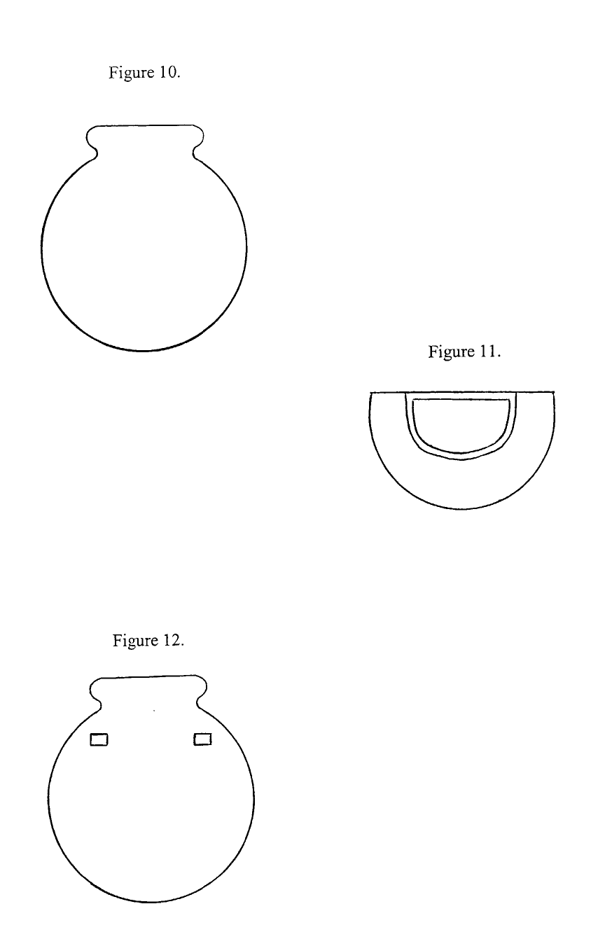

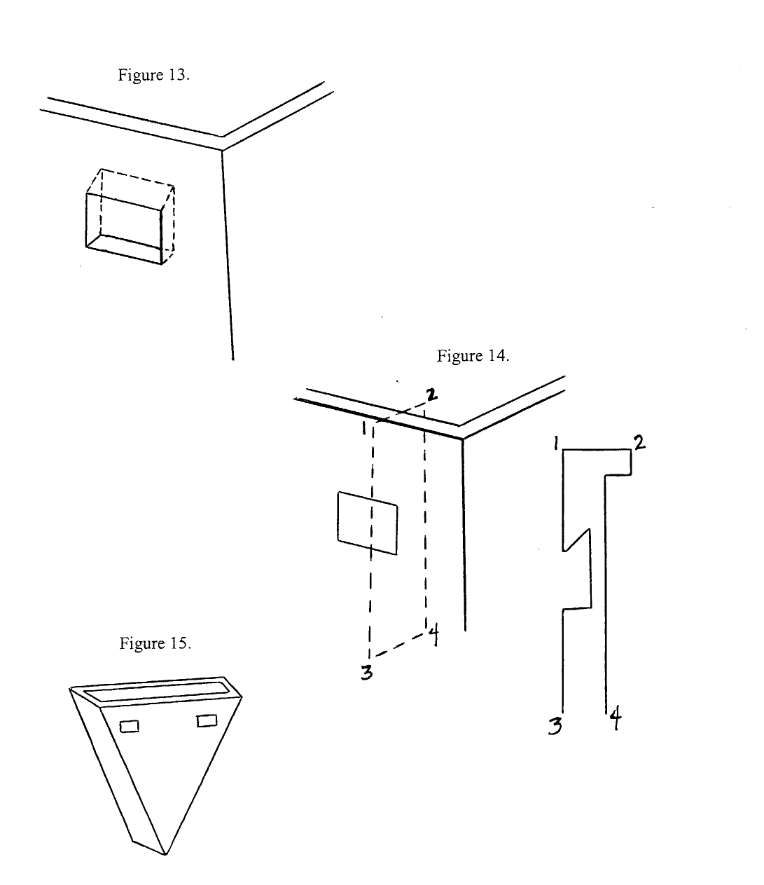

### DETAILED DESCRIPTION OF THE INVENTION

Our invention is a hollow container molded from glass or other transparent material in various shapes and sizes to be used as a fishbowl that will hang on a wall. The fishbowl of whatever shape or size is designed with two indented hollow cavity slots imbedded at the top of its back, near each back edge, which will allow the fishbowl to be placed on and removed from fasteners fixed in a wall, without removing the fasteners.

The container is to be molded from glass or other transparent material with the hanging device molded in its back as described below. The five sides with an opening at the top create a receptacle for holding approximately one to three gallons of water to sustain live fish. (The round bowl is in the shape of a sphere with a flattened back and an opening at the top to create the receptacle. The triangular shape has four sides with an opening at the top to create the receptacle.) The entire opening at the top is rimmed with a one fourth (¼) inch edge toward the inside (water side) of the container to prevent spillage when removing the fishbowl container from the wall for regular cleaning and maintenance. The shapes drawn herein are as follows:

1) Rectangular box, approximately 9″ in height, 12″ in width and 3½″ in depth.

2) Square box with barrel-shaped front, or square front, approximately 12″ in height and 12″ in width, with 3½″ at its greatest depth.

3) Rectangular oval, approximately 10″ in height, 14″ in width and 3½″ in depth. The back of the oval is flattened to accommodate the indented hollow cavity slot hangers.

4) Round fish bowl container, approximately 10″ in diameter and 5-6″ in depth, flattened in the back to accommodate the indented hollow cavity slot hangers.

5) Triangle, approximately 12″ in height and 12″ in width at the top, triangulating down to a slightly rounded point at the bottom, approximately 3½″ in depth.

The back of the molded fishbowl container will be a minimum of three eights (⅜) of an inch thick. Molded into the back, one half (½) of an inch from the right and left side of the back and one half (½) to one inch down from the top edge of the back are two indented hollow cavity slot hangers designed to slip over fasteners (e.g., screws) fixed in a wall at the appropriate distance from one another (i.e., the distance between the center-points of the face, right to left, of each slot hanger). The depths of the slots are one fourth (¼) of an inch. The interior surface of the hollowed out cavity has an overall measurement of three fourths (¾) of an inch width by three fourths (¾) of an inch length. The face of the slot, open to the back to receive the fasteners, will have an opening one half (½) of an inch in width (i.e. from the top to bottom) and three fourths (¾) in length (i.e., from left to right). The top edge of the face slants upward and backward (i.e., toward the water side of the bowl) into the one fourth (¼) inch depth of the slot to meet the top of the three fourths width of the interior surface to provide space into which the head of the fasteners may slide. The fishbowl is mounted by placing the openings in the faces of the slots over the heads of the fixed fasteners. Once the heads of the fasteners have penetrated the slots in the back of the fishbowl, the bowl is lowered until the fasteners catch the space formed by the upward and backward slants of the top indented surface of the slots.

1. We claim a fishbowl designed to hang on a vertical wall, which consists of a hollow container molded from glass or other transparent material in various shapes and sizes to receive water, live fish and other water creatures, designed with indented hollow cavity hangers shaped in its back, which will allow the fishbowl to be slipped on and removed from fasteners attached in a vertical wall without removing the fasteners, said bowl to be rimmed at its mouth to prevent spillage of water during placement and removal.
